(19) United States
(12) Patent Application Publication
(10) Pub. No.: US 2005/0037800 A1
(43) Pub. Date: Feb. 17, 2005

(54) Front end module for mobile telecommunication system

(76) Inventor: Cheng-yen Shih, Taoyuan County (TW)

Correspondence Address: MARTINE & PENILLA, LLP, 710 LAKEWAY DRIVE, SUITE 200, SUNNYVALE, CA, 94085, US

(21) Appl. No.: 10/795,184

(22) Filed: Mar. 3, 2004

(30) Foreign Application Priority Data
Aug. 15, 2003 (TW) 92122575

(51) Int. Cl. H04Q 7/32

(52) U.S. Cl. 455/550.1; 455/552.1

(57) ABSTRACT

A front end module for a mobile telecommunication system includes a diplxer, at least one transmit/receive switch, at least two band-pass filters, at least one low-pass filter, at least one impedance matching circuit and a balun transformer. The diplxer is coupled to an antenna and the transmit/receive switch is coupled to the diplxer for selecting a reception path between the antenna and a receive end, or a transmission path between the antenna and a transmit end. The band-pass filters are each coupled between the transmit/receive switch and the receive end, and the low-pass filter is coupled between the transmit/receive switch and the transmit end. The impedance matching circuit is coupled between the two band-pass filters, and the balun transformer is coupled between the impedance matching circuit and the receive end.

### BACKGROUND OF THE INVENTION

(a) Field of the Invention

The present invention relates to a front end module and, more particularly, to a front end module suitable for a mobile communication system with multi-band capability.

(b) Description of the Related Art

Nowadays, existing mobile phones are mostly either dual-band or triple-band designs. The dual-band mobile phone automatically switches between GSM 900 standard, operated at a frequency band between 880 MHz and 960 MHz, and DCS 1800 standard, between 1710 MHz and 1880 MHz, and the triple-band mobile phone provides another PCS 1900 standard having operating frequencies of 1850 MHz to 1990 MHz.

As an example of the need for multi-band reception and transmission, at least three bands are needed to account for two European (GSM 900/DCS 1800) and one United States (PCS 1900) band. A fourth band (GSM 850) might even be required in South America, and to account for additional services such as multimedia application and fast connection and download to perform high end “world” mobile phones.

Therefore, a well-designed front end module compatible with a quad-band mobile telecommunication system is vital to future demand. Further, since the front end module always includes a lot of passive elements such as capacitors, resistors, filters and impedance converters, an integration of them tends to suffer the disadvantages of low reliability, high cost, and large size. Therefore, an modularized and miniaturized integration for these elements is required to solve these problems.

### BRIEF SUMMARY OF THE INVENTION

Hence, an object of the invention is to provide a front end module compatible with a quad-band mobile telecommunication system and miniaturized through an integration on a multi-layer low temperature co-fired ceramic (LTCC) substrate.

According to the design of the invention, a front end module for mobile telecommunication system includes a diplxer, at least one transmit/receive switch, at least two band-pass filters, at least one low-pass filter, at least one impedance matching circuit and a balun transformer. The diplxer is coupled to an antenna and the transmit/receive switch is coupled to the diplxer for selecting a reception path between the antenna and a receive end, or a transmission path between the antenna and a transmit end. The band-pass filters are each coupled between the transmit/receive switch and the receive end, and the low-pass filter is coupled between the transmit/receive switch and the transmit end. The impedance matching circuit is coupled between the two band-pass filters, and the balun transformer is coupled between the impedance matching circuit and the receive end. Also, the diplxer is composed of two sets of filtering circuits resonating at a first frequency range and a second frequency range, respectively. The first frequency range includes frequency bands conforming to PCS 1900 and DCS 1800 standards, and the second frequency range includes frequency bands conforming to GSM 900 and GSM 850 standards.

Through the design of the invention, the diplexer, low-pass filters, band-pass filters, balun transformer and part of the two transmit/receive switches are deposited and patterned to form the desired electrical interconnections on the LTCC substrate. Since the aforesaid elements are composed of passive components such as resistors, capacitors and inductors, the front-end module according to the invention is integrated into the multi-layer LTCC substrate by forming these passive components on each layer of the LTCC substrate.

Owing to the high dielectricity of the ceramic substrate, the front end module according to the invention can utilize the patterning process to embed a lot of passive components into the ceramic substrate to integrate them at a small size and low cost.

### BRIEF DESCRIPTION OF THE DRAWINGS

FIG. 1 is a block diagram showing a front end module for mobile telecommunication system according to an embodiment of the invention.

FIG. 2 is a perspective view showing the formation of resistors incorporated in the front end module of the invention.

FIG. 3A is a schematic diagram showing the configuration of inductors incorporated in the front end module of the invention.

FIG. 3B is a schematic diagram showing the configuration of capacitors incorporated in the front end module of the invention.

### DETAILED DESCRIPTION OF THE INVENTION

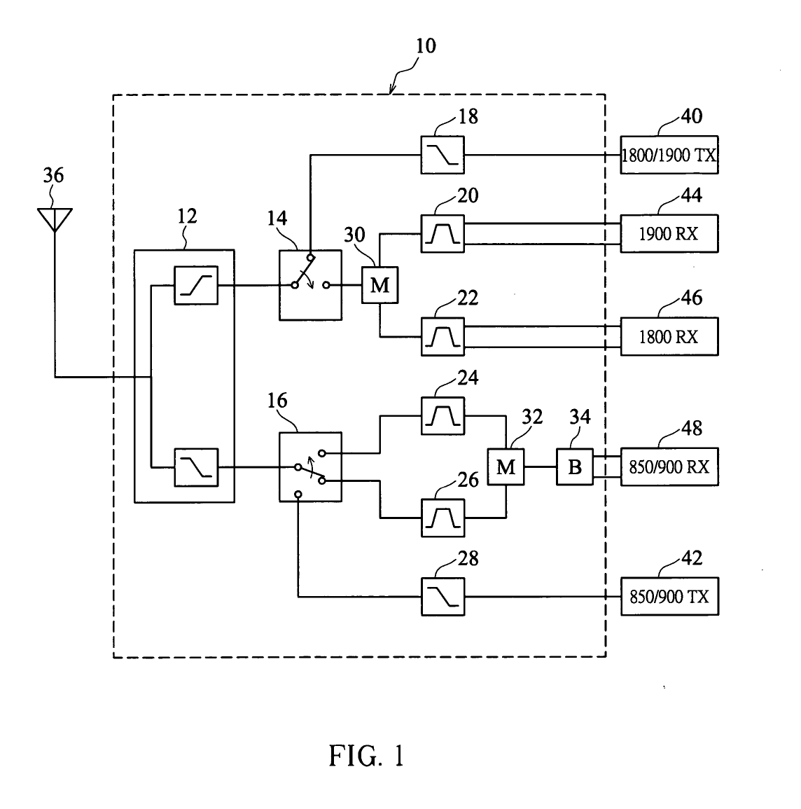

Referring to FIG. 1, a front end module 10 includes a diplexer 12, two transmit/receive switches 14 and 16, two low-pass filters 18 and 28, four band pass filters 20,22,24 and 26, two impedance matching circuits 30 and 32, and a balun transformer 34.

The front end module 10 according to this embodiment is designed to be compatible with a quad-band mobile telecommunication system. Herein, the “quad-band” means radio frequency (RF) signals are transmitted in separate frequency bands conforming to four digital standards, namely GSM 850, GSM 900, DCS 1800 and PCS 1900.

An antenna 36 is designed to receive a signal that is to be fed in receive ends 44, 46 and 48 or to transmit a signal that comes from transmit ends 40 and 42 of the mobile telecommunication system. The diplexer 12 is composed of two sets of filtering circuits resonating at a high frequency range and a low frequency range, respectively. The high frequency range includes frequency bands conforming to PCS 1900 and DCS 1800 standard while the low frequency range includes frequency bands conforming to GSM 900 and GSM 850 standard.

The transmit/receive switches 14 and 16, arranged corresponding to separate frequency ranges of the diplexer 12, allow the antenna 36 to connect to the transmit end or receive end of the mobile telecommunication system.

As shown in FIG. 1, first, RF signals are received through the antenna 36 and then enter the diplexer 12. The diplexer allows the RF signals of high frequency bands conforming to DCS 1800 and PCS 1900 standards to encounter the transmit/receive switch 14, and it allows the RF signals of low frequency bands conforming to GSM 850 and GSM 900 standards to encounter the transmit/receive switch 16.

The transmit/receive switches 14 and 16 may be in either a first position to form a reception path or a second position to form a transmission path. When the transmit/receive switch 14 is switched to the first position to form a reception path where the band pass filters 20 and 22 are positioned, the signals conforming to PCS 1900 standard pass through the filter 20 and are received in the receive end 44 while the signals conforming to DCS 1800 standard pass through the filter 22 and are received in the receive end 46. Herein, impedance matching is accomplished by arranging an impedance matching circuit 30 in the reception path between the filters 20 and 22 to avoid reducing signal intensity or interfering adjacent channel.

On the other hand, when the transmit/receive switch 14 is switched to a second position to form a transmit path, signals of high frequency bands conforming to DCS 1800/PCS 1900 standards and emitted from transmit end 40 are fed into antenna 36 after passing through the low pass filter 18.

Further, when the transmit/receive switch 16 is switched to a first position to form a reception path where the band pass filters 24 and 26 are positioned, signals of low frequency bands conforming to GSM 850 and GSM 900 standards are separated by band pass filters 24 and 26. However, in order to conform to the common chip design for the mobile telecommunication system, an impedance matching circuit 32 is coupled between band pass filters 24 and 26 and the receive end 48, and a balun transformer 34 is coupled between the impedance matching circuit 32 and the receive end 48 so as to transform two unbalance outputs having been passed through filter 24 and 26 into balance ones.

Also, when the transmit/receive switch 16 is switched to a second position to form a transmit path, signals of low frequency bands conforming to GSM 850/GSM 900 standards and emitted from transmit end 42 are fed into antenna 36 after passing through the low pass filter 28.

According to this embodiment, the band pass filter may be a surface acoustic wave (SAW) filter made of piezoelectric material, and the piezoelectric material possesses the characteristic of converting a high-frequency alternating electric signal to an ultrasonic wave having the same frequency.

Particularly, the transmit/receive switch is constructed by a RLC circuit and diodes, and the low pass filter, band pass filter, balun transformer and the diplexer are constructed by LC circuits.

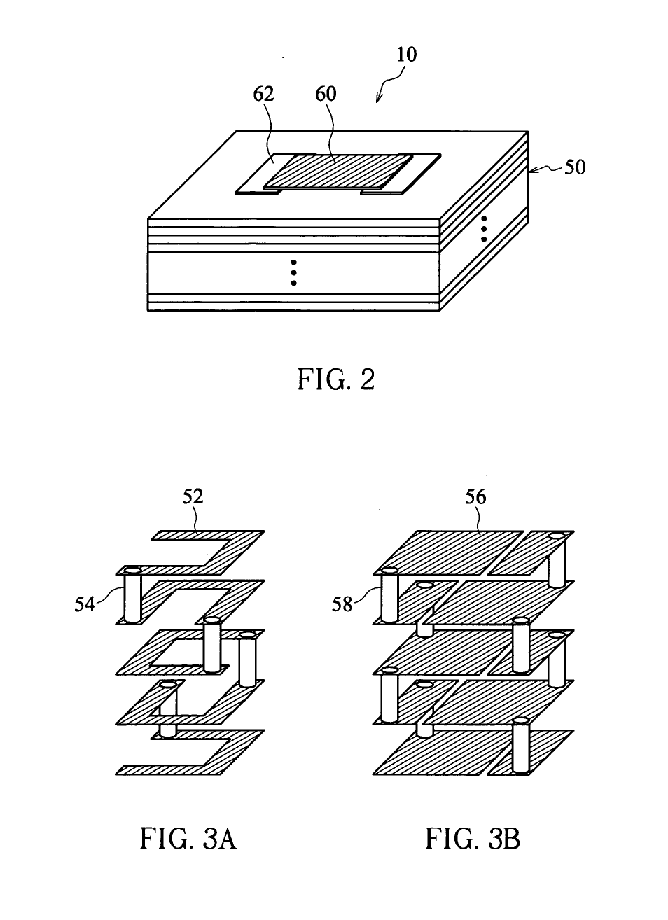

Referring to FIG. 2, the front end module 10 according to the invention is constructed by a multi-layer low temperature co-fired ceramic (LTCC) substrate 50. The LTCC substrate 50 is composed of ceramic dielectric materials with many conductive layers interposed therein.

To be explicit, the diplexer 12, low-pass filters 18 and 28, band-pass filters 20,22,24 and 26, balun transformer 34 and part of the two transmit/receive switches 14 and 16 are deposited and patterned to form the desired electrical interconnections on the LTCC substrate 50. Since the aforesaid elements are composed of passive components such as resistors, capacitors and inductors, the front-end module according to the invention is integrated into the multi-layer LTCC substrate 50 by forming these passive components on each layer of the LTCC substrate 50. In addition to passive components, some semiconductor component are mounted on the skin layer of the LTCC substrate 50 through surface mounting technology (SMT). For example, a diode is typically incorporated in a transmit/receive switch, so the formation of the diode on the skin layer of the LTCC substrate 50 is suitable for applying the SMT.

As shown in FIG. 3A, electrically conductive layers 52 are patterned to be formed into stripped electrodes, as inductors, inside the multilayer LTCC substrate 50. The electrically conductive layers 52, inside which a number of dielectric layers (not shown) are interposed, are connected to each other through metallic via holes 54. Thus, the inductors exhibit a spiral connection inside the multilayer LTCC substrate 50.

On the other hand, as shown in FIG. 3B, electrically conductive layers 56 are patterned to be formed into sheet electrodes, as capacitors, inside the multilayer LTCC substrate 50. Also, the electrically conductive layers 56, inside which a number of dielectric layers (not shown) are interposed, are connected to each other through metallic via holes 58. Thus, the capacitors exhibit a stack connection inside the multilayer LTCC substrate 50. Further, a surface-mounted diode in a transmit/receive switch is electrically connected to the LC circuit constructed by aforesaid capacitors and inductors through the metallic via hole.

Referring again to FIG. 2, the resistors are fabricated by thin film technology such as ink printing. The ink film 60 with characteristic impedance is printed on the surface electrodes 62 on the skin layer of the LTCC substrate 50 at a specific length/breadth ratio.

On the skin layer of the LTCC substrate 50, not only the ink-printed resistors but the surface-mounted semiconductor components such as an IC and a diode are formed. Those components are connected to the LC circuits through the aforesaid metallic via holes 54 and 58, and they are mounted on the skin layer of the LTCC substrate 50 just as in the case of the resistors exhibited in FIG. 2.

Owing to the high dielectricity of the ceramic substrate, the front end module according to the invention can utilize the patterning process to embed a lot of passive components into the ceramic substrate to integrate them at a small size and low cost.

Moreover, the front-end module of the invention suitable for a quad-band mobile phone is also applicable to a triple-band or dual-band design. For example, simply by eliminating the band-pass filter 24 associated with the GSM850 standard from the design architecture, the present design works as being applied to a triple-band mobile phone.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A front end module for mobile telecommunication system, comprising:
a diplxer coupled to an antenna;
at least one transmit/receive switch coupled to the diplxer for selecting a reception path between the antenna and a receive end, or a transmission path between the antenna and a transmit end;
at least two band-pass filters each coupled between the transmit/receive switch and the receive end;
at least one low-pass filter coupled between the transmit/receive switch and the transmit end;
at least one impedance matching circuit coupled between the two band-pass filters; and
a balun transformer coupled between the impedance matching circuit and the receive end.

2. The front end module of claim 1, wherein the diplxer is composed of two sets of filtering circuits resonating at a first frequency range and a second frequency range, respectively, and the transmit/receive switch is arranged corresponding to the first and the second frequency ranges.

3. The front end module of claim 1, wherein the first frequency range includes frequency bands conforming to PCS 1900 and DCS 1800 standards, and the second frequency range includes frequency bands conforming to GSM 900 and GSM 850 standards.

4. The front end module of claim 1, wherein the band pass filters are surface acoustic wave (SAW) filters.

5. The front end module of claim 1, wherein the diplexer, the band-pass filters, the low-pass filter, the balun transformer and part of the transmit/receive switch are constructed of capacitors, inductors and resistors, and the capacitors, inductors and resistors are formed on a multi-layer low temperature co-fired ceramic (LTCC) substrate through patterning.

6. The front end module of claim 5, wherein the capacitors and inductors are formed from electrically conductive layers interposed in the layers of the multi-layer LTCC substrate and interconnected through metallic via holes.

7. The front end module of claim 6, wherein the inductors are shaped in the form of a spiral connection, and the capacitors are shaped in the form of a stack connection.

8. The front end module of claim 5, wherein the resistors are ink films with characteristic impedance printed on a skin layer of the multi-layer LTCC substrate.

9. The front end module of claim 5, wherein the multi-layer LTCC substrate mounts semiconductor components on its skin layer.

10. The front end module of claim 9, wherein the multi-layer LTCC substrate mounts the semiconductor components through surface mounting technology (SMT).

11. The front end module of claim 9, wherein the semiconductor components include a diode.

12. A front end module for mobile telecommunication system, comprising:
a diplxer coupled to an antenna, the diplxer having two sets of filtering circuits resonating at a first frequency range and a second frequency range, respectively;
a first transmit/receive switch, arranged corresponding to the first frequency range and coupled to the diplxer for selecting a first reception path between the antenna and a receive end, or a first transmission path between the antenna and a transmit end;
a second transmit/receive switch, arranged corresponding to the second frequency range and coupled to the diplxer for selecting a second reception path between the antenna and a receive end, or a second transmission path between the antenna and a transmit end;
four band-pass filters, where two band-pass filters are coupled between the first transmit/receive switch and the receive end, and other two band-pass filters are coupled between the second transmit/receive switch and the receive end;
two low-pass filters, where one low-pass filter is coupled between the first transmit/receive switch and the transmit end, and the other low-pass filter is coupled between the second transmit/receive switch and the transmit end;
two impedance matching circuit coupled between the two band-pass filters; and
a balun transformer coupled between the impedance matching circuit and the receive end.

13. The front end module of claim 12, wherein the first frequency range includes frequency bands conforming to PCS 1900 and DCS 1800 standards, and the second frequency range includes frequency bands conforming to GSM 900 and GSM 850 standards.

14. The front end module of claim 12, wherein the band pass filters are surface acoustic wave filters.

15. The front end module of claim 12, wherein the diplexer, the band-pass filters, the low-pass filters, the balun transformer and part of the transmit/receive switches are constructed of capacitors, inductors and resistors, and the capacitors, inductors and resistors are formed on a multi-layer LTCC substrate through patterning.

16. The front end module of claim 15, wherein the capacitors and inductors are formed from electrically conductive layers interposed in the layers of the multi-layer LTCC substrate and interconnected through metallic via holes.

17. The front end module of claim 15, wherein the inductors are in the form of a spiral connection, and the capacitors are in the form of a stack connection.

18. The front end module of claim 15, wherein the resistors are ink films with characteristic impedance printed on a skin layer of the multi-layer LTCC substrate.

19. The front end module of claim 15, wherein the multi-layer LTCC substrate mounts semiconductor components on its skin layer.

20. The front end module of claim 19, wherein the multi-layer LTCC substrate mounts the semiconductor components through surface mounting technology.
